(19) United States
(12) Patent Application Publication
(10) Pub. No.: US 2017/0361672 A1
(43) Pub. Date: Dec. 21, 2017

(54) ELECTRO-DYNAMICALLY CONTROLLED LEVELING SYSTEM

(71) Applicant: System Integrators International, LLC, Blacksburg, VA (US)

(72) Inventor: Mehdi AHMADIAN, Blacksburg, VA (US)

(73) Assignee: System Integrators International, LLC, Blacksburg, VA (US)

(21) Appl. No.: 15/626,493

(22) Filed: Jun. 19, 2017

Related U.S. Application Data
(60) Provisional application No. 62/352,228, filed on Jun. 20, 2016.

(51) Int. Cl. B60G 17/015; B60G 17/019; B60G 11/27; B60G 17/04; B60G 17/052; B60G 17/016; B60G 17/033

(52) U.S. Cl. CPC B60G 17/0155; B60G 17/0161; B60G 17/0162; B60G 17/0164; B60G 17/019; B60G 17/033; B60G 17/0408; B60G 17/0528; B60G 11/27; B60G 2400/202; B60G 2400/106; B60G 2400/104; B60G 2400/0523; B60G 2400/0522; B60G 2400/0521; B60G 2400/0512; B60G 2400/0511; B60G 2202/42; B60G 2202/152; B60G 2400/204; B60G 2400/25; B60G 2400/34; B60G 2400/39; B60G 2400/41; B60G 2400/51222; B60G 2500/202; B60G 2800/012; B60G 2500/204

(57) ABSTRACT

An electro-dynamically controlled leveling system having a plurality of air springs mounted on at least one axle of a vehicle for supporting the weight of the vehicle; one or more electro-pneumatic valves; and one or more sensors that monitor one or more characteristics of the vehicle and transmit the one or more characteristics as a sensory input. The electro-dynamically controlled leveling system includes a central control module in electrical communication with the one or more sensors and the one or more electro-pneumatic valves. The central control module receives the sensory input from the one or more sensors, calculates a dynamic condition of the vehicle based on the sensory input, determines a desired air pressure for each air spring based on the calculated dynamic conditions of the vehicle, and transmit a command to the electro-pneumatic valves to adjust the air pressure of the air springs.

### CROSS REFERENCE OF RELATED APPLICATION

This application claims the benefit under 35 U.S.C. §119(e) of the filing date of provisional patent application Ser. No. 62/352,228 filed Jun. 20, 2016, the disclosure of which is incorporated herein by reference in its entirety.

### FIELD OF THE DISCLOSURE

This disclosure relates to an electronically controlled dynamic leveling system that improves roll stability, ride comfort, and road holding of a vehicle using a pneumatic air suspension system.

### BACKGROUND

Pneumatic air suspension systems commonly include an air tank that supplies air to air springs (also referred to as air suspension bags or air bags) that are installed at the axles, in between the vehicle frame or body. The air tank is connected to the air springs through a series of hoses and connectors that transfer air from the air tank to the air springs. In some cases, check valves and regulators are incorporated in line with air hoses in order to provide the necessary protection to prevent over-inflating the air springs or depleting the air tank in case of air spring failure. The pneumatic suspension commonly incorporates a load-leveling valve that can adjust the pressure in the air spring based on the wheel load or the vehicle load.

Most common air suspensions in vehicles including, but not limited to, heavy trucks use a mechanical load leveling valve that adjusts the air pressure within the air suspension in response to the load placed on the suspension. When the vehicle is loaded, the air pressure is increased for higher suspension stiffness and better supporting the added weight (load) placed on top of the suspension. Conversely, when load is removed, the air pressure is decreased to provide a softer suspension and prevent the vehicle frame from jacking up. The end result is a vehicle that rides “level,” meaning it rides at the same ride height independent of its loading condition. The load leveling is accomplished through the aforementioned mechanical leveling valve, commonly referred to as “load leveling valve,” or “ride height control valve.”

Once the truck body is leveled to a set ride height, the valve remains predominantly closed, in the sense that the valve does not remove or add any air to the suspension air springs. When, however, the vehicle body is raised or lowered, the valve adds or removes air from the suspension to return the body back to the set ride height. For suspensions with one leveling valve, such adjustment happens in response to the side of the vehicle to which the valve is connected. On the other hand, for suspensions with two load leveling valves, the air in each side is adjusted independent of the other side, allowing for better static and dynamic leveling of the body. For instance, when the vehicle is unleveled side-to-side, one side is raised while the other side is lowered. In such a case, the leveling valve on the lower side adds air to the suspension, whereas the valve on the other side does the opposite by removing air from the suspension. Thereby, the leveling valves on the two sides preform diametrically opposite of each other: one releasing air to lower the body relative to the axle while the other one adding more air to raise the body. One leveling valve increases the suspension stiffness while the other reduces it.

In either a single valve suspension system or a double valve suspension system, load leveling valves of the prior art are actuated by a mechanical means that typically includes an arm connected to a linkage, hereinafter referred to as “control rod,” which attaches to the bottom or axle side of the suspension system. The connection of the control rod between the load leveling valve arm and the bottom of the suspension system transmits movement from the air springs in the vertical direction to the valve arm in a rotational direction. Accordingly, the movement of the suspension system triggers the load leveling valve to supply or exhaust air to and from the air springs, thereby the ride height of the vehicle is controlled completely in response to the movement of the suspension system.

However, while in motion, a vehicle often experiences dynamic, side-to-side or front-to-back weight shifts that cause the vehicle to roll or pitch at a sudden movement. Such weight shifts occur as a result of the vehicle traveling on a curved roadway, or during acceleration and deceleration. Roll implies the angular motion of the vehicle body relative to its longitudinal axis, i.e., the axis that extends from the back of the vehicle to front. Such motions predominantly occur when the vehicle is subjected to lateral forces during steering maneuvers; for instance, when the vehicle is negotiating a curved pathway or turn. Pitch is the angular motion of the vehicle about its lateral axis, the axis extending from one side to the opposite side of the vehicle. Pitch occurs when the vehicle is subjected to longitudinal forces, for instance while accelerating and braking. Because load leveling valves of the prior art are predominantly intended to provide body leveling in a static sense, they are slow to respond to dynamics, such as side-to-side or front-to-back weight shifts of the vehicle. Consequently, conventional pneumatic air suspension systems tend to respond too late to an impulsive weight shift of a moving vehicle, ultimately proving to be ineffective in preventing body roll and pitch. In extreme cases, such body movements can result in rollovers in places such as sharp turns. Such rollovers are often disastrous.

Accordingly, there is a need for a pneumatic air suspension system that can respond quickly to a dynamic weight shift in a moving vehicle to reduce the possibility of the vehicle overturning at a sudden change of movement, such as a sharp turn. Furthermore, there is a need for a pneumatic air suspension system that controls the supply and exhaust of air to and from the air springs based on the vehicle operating condition and total body movement, beyond the movement of the suspension system, in a manner that the ride height of the vehicle is controlled, proactively and dynamically, through sensing and predicting the dynamic conditions of the vehicle.

### SUMMARY

The present invention provides an electro-dynamically controlled leveling system for a vehicle, in which the electro-dynamically controlled leveling system includes a plurality of air springs mounted on at least one axle of the vehicle for supporting the weight of the vehicle; one or more electro-pneumatic valves configured to adjust the air pressure of the plurality of air springs by supplying air to the plurality of air springs from an air source or removing air from the plurality of air springs; one or more sensors configured to monitor one or more characteristics of the vehicle and transmit the one or more characteristics as a sensory input; and a central control module (CCM) in electrical communication with the one or more sensors and the one or more electro-pneumatic valves. The CCM is configured to receive the sensory input from the one or more sensors, calculate a dynamic condition of the vehicle based on the sensory input, determine a desired air pressure for each air spring based on the calculated dynamic conditions of the vehicle, and transmit a command to the one or more electro-pneumatic valves to adjust the air pressure of each air spring to the desired air pressure.

The one or more characteristics monitored by the sensors may include a steering angle, vehicle lateral acceleration, vehicle longitudinal acceleration, roll angle of the vehicle, roll rate of the vehicle, pitch angle of the vehicle, pitch rate of the vehicle, yaw rate of the vehicle, air pressure of the plurality of air springs, vehicle speed, suspension displacement, suspension velocity, accelerator position, or brake pressure. The dynamic condition calculated by the CCM may include the vehicle's body roll, the vehicle's body pitch, or both the vehicle's body roll and body pitch. In one configuration, the dynamic condition may include the vehicle's body roll and the one or more characteristics of the vehicle may include the vehicle lateral acceleration, the roll angle, and the roll rate. In another configuration, the dynamic condition may include the vehicle's body roll and the one or more characteristics of the vehicle may include suspension displacement and suspension velocity. In another configuration, the dynamic condition may include vehicle's body pitch and the one or more characteristics of the vehicle may include a forward speed of the vehicle, an accelerator position of the vehicle, and a brake pressure.

The electro-pneumatic valves may include a valve body having one or more airflow passages in pneumatic communication with an air source, the atmosphere, and at least one of the air springs, and an actuator mechanism configured to open or close the airflow passages of the valve body, wherein the CCM is configured to trigger the actuator mechanism by electrical communication to open or close the airflow passages of the valve body. In one configuration, the valve body includes a chamber connected to the one or more flow passages and a disk configured to rotate between one or more angular positions within a chamber of the valve body to alter pneumatic communication between the flow passages, and the actuator mechanism includes a stepper motor configured to induce rotation of the rotary disk to the one or more angular positions. In another configuration, the valve body includes a manifold having a spring port, a supply port, an exhaust port, and a chamber connected with the spring port, supply port, and exhaust port, and the actuator mechanism includes a solenoid and a poppet received in the chamber of the manifold. The poppet is configured to slide between a first and second position to alter pneumatic communication between the spring port, the supply port, and the exhaust port, and the CCM is configured to control movement of the poppet by triggering the solenoid via electrical communication.

Other features and characteristics of the subject matter of this disclosure, as well as the methods of operation, functions of related elements of structure and the combination of parts, and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

The accompanying drawings, which are incorporated herein and form part of the specification, illustrate various embodiments of the subject matter of this disclosure. In the drawings, like reference numbers indicate identical or functionally similar elements.

FIGS. 1A and 1B are schematic views of a pneumatic suspension system of the prior art.

FIGS. 2A, 2B, and 2C are schematic views of electro-dynamic controlled leveling systems according to configurations of the present invention.

FIG. 3A is a top view of an electro-pneumatic valve according to a configuration of the present invention. FIG. 3B is a cross-sectional view of an electro-pneumatic valve according to a configuration of the present invention.

FIGS. 4A and 4B are cross-sectional views of an electro-pneumatic valve according to a configuration of the present invention.

FIGS. 5A, 5B, and 5C are wiring diagrams of electrodynamic controlled leveling systems according to configurations of the present invention.

FIG. 6 is a control loop of an electro-dynamic controlled leveling system according to a configuration of the present invention.

FIG. 7 is a flow diagram of an operation procedure for a CCM according to a configuration of the present invention.

FIG. 8 is a block diagram of the sensory inputs for a CCM according to a configuration of the present invention.

FIG. 9 is a schematic force body diagram of a vehicle having a pneumatic suspension system.

FIGS. 10-12 are block diagrams of methods of calculating a body roll according to a configuration of the present invention.

FIG. 13 is a block diagram of an overall method of calculating a body roll according to a configuration of the present invention.

FIGS. 14 and 15 are block diagrams of methods of calculating a body pitch according to a configuration of the present invention.

FIG. 16 is a block diagram of an overall method of calculating a body pitch according to a configuration of the present invention.

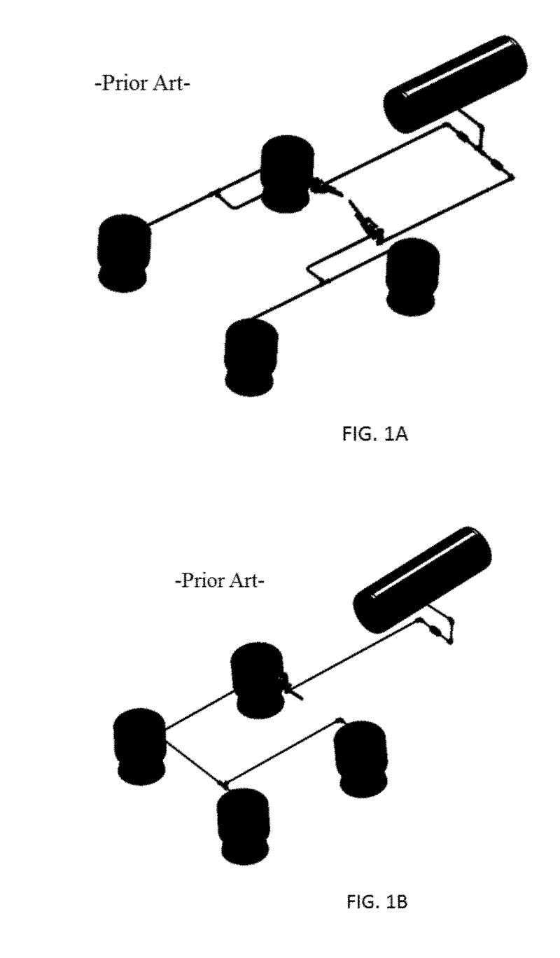

### DETAILED DESCRIPTION

While aspects of the subject matter of the present disclosure may be embodied in a variety of forms, the following description and accompanying drawings are merely intended to disclose some of these forms as specific examples of the subject matter. Accordingly, the subject matter of this disclosure is not intended to be limited to the forms or embodiments so described and illustrated.

The disclosure relates to an electro-dynamically controlled (EDC) leveling system for controlling the static and dynamic ride height of a vehicle through a mechanism that can be controlled in real time, such as, but not limited to, one or more electro-pneumatic dynamic (EPD) valves, in which each EPD valve is capable of supplying or removing air from a set of air springs mounted on a vehicle axle. As will be discussed further herein below, the EDC leveling system includes one or more EPD valves interfacing with a CCM that provides the requisite input based on the characteristics and dynamics of the vehicle for any actions executed by the electro-pneumatic valve, such as adding air to or removing air from the air springs. The EDC leveling system further implements an integration of devices, such as, but not limited to, embedded analog/digital controllers, sensors, and data already available on a vehicle through a Controller Area Network (CAN) Bus or other such means. The CCM interacts with the integration of devices so that the CCM may sense and determine the vehicle's dynamics, the vehicle operator's commands, and the suspension response. Accordingly, the EDC leveling system may manage the internal air pressure of each air spring based on various inputs, ultimately providing proactive control of the suspension system.

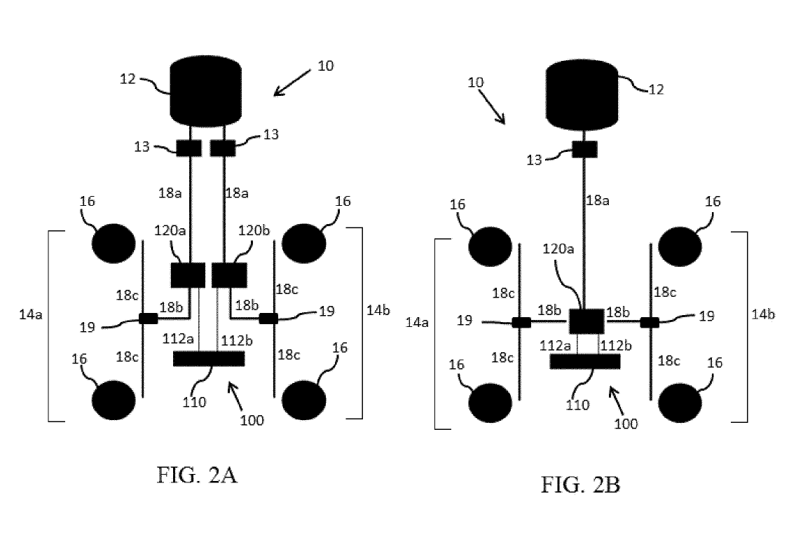

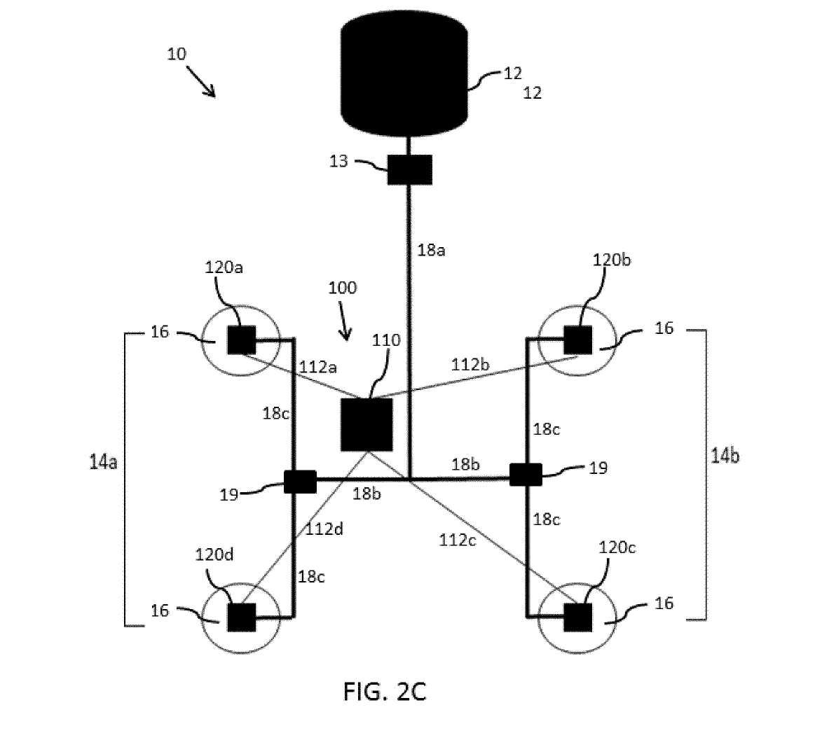

FIG. 2A illustrates a pneumatic suspension system 10 of a vehicle incorporating an EDC leveling system 100 according to the general inventive concept. The pneumatic suspension system 10 includes an air source, such as a supply tank 12, for supplying air to two pneumatic circuits 14a, 14b. Each pneumatic circuit 14 includes a set of air springs 16 positioned on a respective side of a vehicle (not shown) and is connected to the supply tank 12 by an EPD valve (120a or 120b) and a series of air hoses 18a-c. The series of air hoses 18a-c include a supply hose 18a connecting the supply tank 12 to a respective EPD valve (120a or 120b). Each supply hose 18a is further provided with a pressure protection valve 13. A valve hose 18b extends between the EPD valve (120a or 120b) and a respective air fitting 19. Furthermore, the series of air hoses 18a-c include two pairs of spring hoses 18c, in which each spring hose 18c extends between a respective air fitting 19 and a respective air spring 16. The pneumatic suspension system may include other air fittings (not shown) to connect the air hoses to each other, and other components of the pneumatic suspensions system, as well. The types of air fittings may include elbows, T-connectors, adaptors, etc.

As shown in FIG. 2A, the EDC leveling system 100 for the pneumatic suspension system 10 includes a central control module 110 in electrical communication with two EPD valves 120a, 120b through electrical wiring 112a, 112b, in which each EPD valve is implemented with a respective pneumatic circuit. However, other forms of communication may be provided to establish electrical communication between the CCM 110 and the EPD valves 120a, 120b, such as wireless communication or digital connection, without departing from spirit and scope of the present invention. Referring to FIG. 2A, each EPD valve controls the air pressure of springs on a respective side of the vehicle. In alternative configuration shown in FIG. 2B, the EDC leveling system 100 for the pneumatic suspension system 10 includes only one EPD valve 120a in electrical communication with the CCM 110 through electrical wiring 112a. Rather than controlling the air pressure of the air springs on one side of the vehicle, the EPD valve 120a shown in FIG. 2B controls the air pressure of the air springs on both sides of the vehicle. The two pneumatic circuits 14a, 14b of FIG. 2B are linked together by the EPD valve and only one supply air hose 18a connecting the EPD valve to the supply tank 12.

In another configuration shown in FIG. 2C, the EDC leveling system 100 includes four EPD valves 120a-d, each corresponding to an individual air spring 16, so that each EPD valve only controls the air pressure of an individual air spring 16. For each configuration described above, the CCM 110 receives inputs regarding the vehicle's dynamics, the vehicle operator's commands, and the suspension response, and the CCM 110 outputs commands to the one or more EPD valves 120a-d so that each air spring 16 is set to a desired air pressure that promotes roll stability, ride comfort, and road holding for the vehicle.

Referring to FIGS. 2A-C, the supply tank 12 serves as the reservoir for supplying air to the pneumatic circuits 14a and 14b. In one configuration, the supply tank 12 is made of a sufficiently strong material to hold pressurized air. The supply tank 12 is configured to provide sufficient air to the air springs 16 during repeated cycles of purging and supplying air. To ensure that the supply tank 12 is configured to provide sufficient air to the air springs 16, the air pressure of the tank is regulated to a nominal pressure. When the air pressure of the supply tank 12 falls below the nominal pressure, the supply tank 12 is replenished with air from a compressor (not shown). Once the air pressure of the supply tank 12 reaches a set maximum limit, the compressor cuts out and no additional air is provided to the supply tank 12.

As shown in FIGS. 2A-C, the series of air hoses 18a-c connect and establish pneumatic communication between various components of the pneumatic suspension system 10. In one configuration, the air hoses 18a-c are made of a polymer that is flexible enough for routing around the vehicle, yet strong enough for sustaining high pressure air. The air hoses 18a-c may be made from various classes of polymers, plastics, or similar synthetic materials. The air hoses 18a-c may also be reinforced with cords to increase their ability to sustain high-pressure air. To simplify the installation process, the air hoses 18a-c may be made in various colors to ease the identification of a particular air hose and provide better visual instruction during the installation process.

Referring to FIGS. 2A-C, the air springs 16 are placed in between the vehicle axle and chassis or frame (not shown) to provide compliance for the pneumatic suspension system. In one configuration, each air spring 16 is a canister-like element having rubber sidewalls that inflate or deflate in the primary direction of suspension travel, most commonly in the vertical direction. A change in the internal pressure of the air springs 16 alters the separation distance between the vehicle body and axle, thereby raising or lowering the vehicle body relative to the axle. When air is added to the air springs 16, the internal air pressure of the air springs 16 increases and raises the vehicle body from the axle. In contrast, when air is removed from the air springs 16, the internal air pressure of the air springs decreases and lowers the vehicle body toward the axle. In addition, adding or removing air from the air springs 16 increases or decreases the suspension stiffness, respectively. Managing the internal air pressure of the air springs 16 allows control of the height of each vehicle side relative to the ground and the compliance of the suspensions. Changes between the heights of each vehicle side affect the vehicle body roll angle and stability. Compliance of the suspensions affects the vehicle ride comfort. Accordingly, the ECD system 100 controls both the roll stability and ride quality of the vehicle by controlling the air pressure of each individual air spring 16 through the EPD valve.

As shown in FIGS. 2A-C, each supply hose 18a is provided with a pressure protection valve 13. The pressure protection valve 13 is adapted to prevent a complete loss of pressure within the supply tank 12, in case of a failure of the pneumatic suspension system 10, such as a punctured air spring or hose or a failed connector. Similar to the operation of a check valve, the pressure protection valve 13 is held in an open state if the pressure in the supply tank 12 is above a minimum pressure threshold, thereby permitting air flow from the supply tank 12 to the air springs 16. However, if the internal pressure of the supply tank 12 falls below the minimum pressure threshold, the pressure protection valve 13 switches to a closed state, thereby preventing air flow from the supply tank 12 to the air springs 16. Accordingly, the supply tank 12 becomes isolated from the air springs 16 during a failure in the pneumatic suspension system, which prevents the supply tank 12 from being completely depleted of air.

The supplying and discharging of air into and out of the air springs 16 of the pneumatic system 10 shown in FIGS. 2A-C are controlled by the one or more EPD valves 120. The one or more EPD valves 120 generally include a valve body connected to and operated by an actuating mechanism (e.g., a solenoid, stepper motor, or the like). The valve body includes one or more airflow passages pneumatically linked to the supply tank 12, the air springs 16, and the atmosphere. The valve body is configured to shuttle air flow between the supply tank 12 and the air springs 16 shown in FIGS. 2A-C. The one or more EPD valves 120 control the air flow between the supply tank 12 and the air springs 16 by the supply of an electrical current or voltage that triggers the actuation mechanism (e.g., a solenoid, stepper motor, or the like) to open or close airflow passages within the valve body.

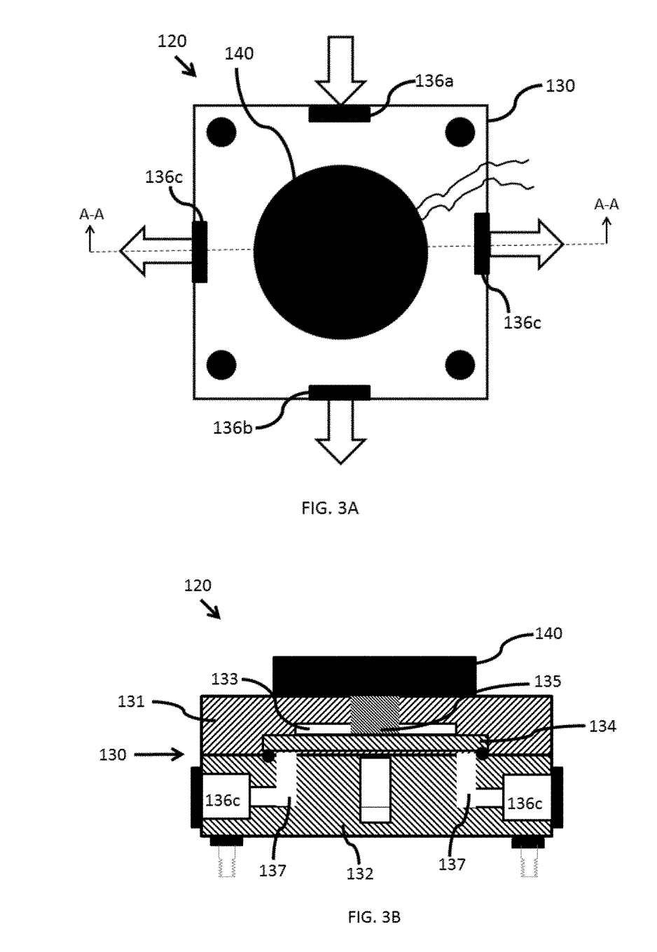

According to one configuration of the EPD valve 120 shown in FIGS. 3A and 3B, the EPD valve 120 includes a valve body 130 and an actuation mechanism such as a stepper motor 140. Referring to FIG. 3B, the valve body 130 is formed by an upper housing 131 mounted on a lower housing 132, wherein a chamber 133 is defined between the upper housing 131 and the lower housing 132. The lower housing 132 includes a supply port 136a, an exhaust port 136b, and one or more spring ports 136c. The ports 136a-c are pneumatically linked to the chamber 133 by airflow passages 137 formed in the lower housing 132 of the valve body 130, in which each port 136a-c is connected to the chamber 133 by a respective airflow passage 137. The electro-pneumatic dynamic valve 120 further includes a rotary disk 134 received in the chamber 133 of the valve body 130. The rotary disk 134 is configured to rotate freely within the chamber 133 about a shaft 135, which extends through the upper housing 131 to the stepper motor 140. As shown in FIGS. 3A and 3B, the stepper motor 140 is connected to the rotary disk 134 by the shaft 135 such that the stepper motor 140 induces rotation of the rotary disk 134, which shuttles air between the supply port 136a, the exhaust port 136b, and the one or more spring ports 136c. The rotary disk 134 is configured to rotate between a plurality of angular positions to alter the pneumatic communication between the ports 136a-c of the valve body 130.

In operation, the stepper motor 140 positions the rotary disk 134 to a desired location within the chamber 133 of the valve body 130 to direct airflow from the supply tank 12 to the one or more air springs 16. In addition, when necessary, the rotary disk 134 purges air from the air springs 16 to the atmosphere. The stepper motor 140 may rotate the rotary disk 134 to a base position, in which spring ports 136c pneumatically communicate neither with the supply port 136a nor the exhaust port 136b. The stepper motor 140 may rotate the rotary disk 134 to first and second angular positions, in which the supply port 136a pneumatically communicates with one of the spring ports 136c and the exhaust port 136b communicates with the other one of the spring ports 136c. Accordingly, air is supplied to one of the spring ports 136c, while air is purged from the other one of the spring ports 136c. Moreover, the air flow through one spring port versus the other port can be asymmetric, in which one of the spring ports 136c can receive more or less air flow than the other one of the spring ports 136c. Thus, the supplying and purging of the air for two air springs 16 is independent of each other so that one side of a vehicle may be raised and the other side of the vehicle be lowered simultaneously. The EPD valve 120 shown in FIGS. 3A and 3B may be used with either EDC leveling system 100 shown in FIGS. 2A and 2B.

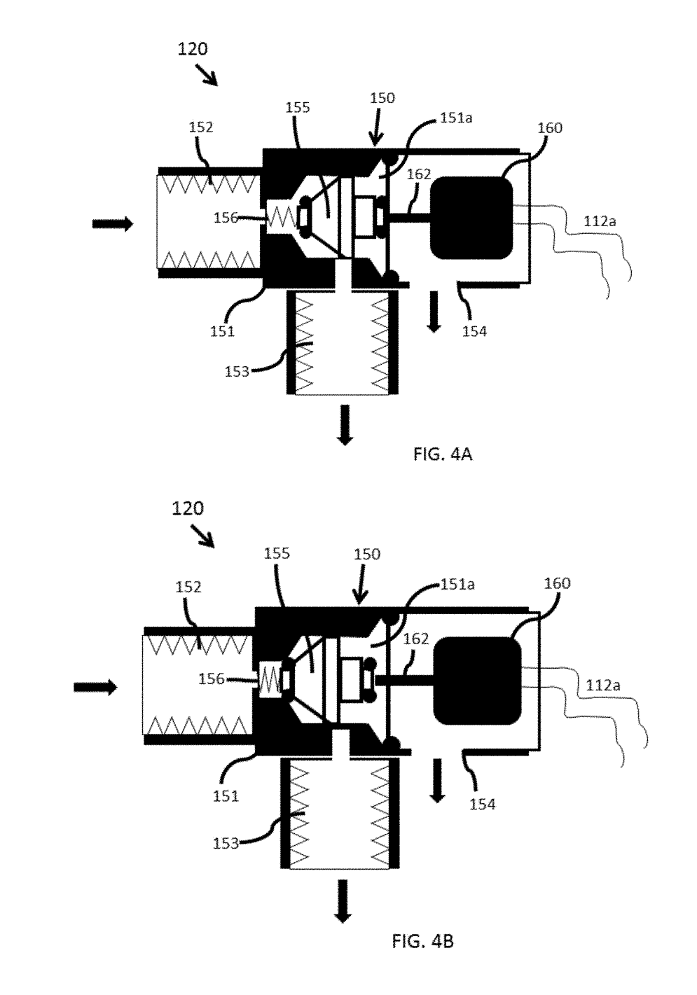

FIGS. 4A and 4B illustrate another configuration of the EPD valve 120 incorporated into the EDC leveling system 100 shown in FIG. 2C, in which the EPD valve 120 is configured to control the air pressure of an individual air spring 16. Rather than controlling the air pressure of multiple air springs through the use of one actuator mechanism as shown in FIGS. 3A and 3B, the EPD valve 120 shown in FIGS. 4A and 4B uses one actuator mechanism (e.g., a solenoid, a stepper motor, or the like) to control the air pressure of only one individual air spring 16 independent of the other air springs 16 installed on the vehicle. Accordingly, the air pressure and the force of one air spring 16 are controlled independent of the air pressure and forces of other air springs 16, thereby providing enhanced dynamic control for the vehicle body and axle.

As shown in FIGS. 4A and 4B, the EPD valve 120 includes a valve body 150 and an actuation mechanism such as a solenoid 160. The valve body 150 includes a manifold 151 defining a chamber 151a. The valve body 150 further includes a supply port 152, a spring port 153, and an exhaust port 154 connected with the manifold 151 and pneumatically linked with the chamber 151a of the manifold 151. The supply port 152 is pneumatically linked to the supply tank 12, and the exhaust port 154 is open to the atmosphere. The spring port 153 is pneumatically linked to an individual air spring 16 and is configured to attach directly to an individual air spring 16 of the pneumatic suspension system 10. The valve body 150 further includes a poppet 155 received in the chamber 151a of the manifold 151, in which the poppet 155 is configured to alter communication between the supply port 152, the spring port 153, and the exhaust port 154 by sliding between a first position and a second position. Referring to FIG. 4A, the poppet 155 is biased by linear spring 156 in the first position, wherein the spring port 153 is in pneumatic communication with the supply port 152 but not in pneumatic communication with the exhaust port. The solenoid 160 is received in the chamber 151a of the manifold 151 and is connected to the poppet 155 by a plunger 162, which is configured to slide in a direction parallel to the linear spring 156 between an extended position and a retracted position. As shown in FIG. 4A, the plunger 162 of the solenoid 160 is in a retracted position so that the linear spring 156 biases the poppet 155 to the first position. Referring to FIG. 4B, the plunger 162 of the solenoid 160 slides to the extended position overcoming the bias of the linear spring 156 so that the poppet 155 slides forward to the second position, wherein the spring port 153 is in pneumatic communication with the exhaust port 154 but not in pneumatic communication with the supply port 152.

In operation, the solenoid 160 may switch between different states, including an inactivated state and an activated state. When the solenoid 160 is set to the inactivated state, the plunger 162 is set to the retracted position shown in FIG. 4A. Accordingly, the spring port 153 is in pneumatic communication with the supply port 152 so that the air spring 16 receives air from the supply tank 12. When electrical power is supplied to the solenoid 160 so that the solenoid 160 switches to the activated state, the plunger 162 slides to the extended position, thereby forcing the poppet 155 to move to the second position shown in FIG. 4B. Accordingly, the spring port 153 is in pneumatic communication with the exhaust port 154 to reduce the air pressure of the air spring 16. In both the supply and purge configurations (FIGS. 4A and 4B), the EPD valve 120 manages the air flow such that the proper rate is achieved for dynamic control of the body and axle. Although the EPD valve 120 shown in FIGS. 4A and 4B is incorporated into the EDC leveling system 100 shown in FIG. 2C, the EPD valve 120 of FIGS. 4A and 4B may also be used in the EDC leveling system 100 shown in FIGS. 2A and 2B.

The EDC leveling system further includes a series of sensors (not shown) such as, but not limited to, pressure sensors, roll rate sensor, yaw rate sensor, pitch rate sensor, accelerometers, gyros, velocity and displacement sensors (such as haul effect sensors or linear voltage differential transformers (LVDT)), steering wheel angle sensor, steering column sensors, and height sensors. The sensors may also obtain information through vehicle to infrastructure (V2I), vehicle to vehicle (V2V), and Vehicle to other communication networks, which are collectively known as V2X. The sensors are arranged along the vehicle so that conditions and road input measured at the vehicle's front end may be inputted to anticipate conditions for suspensions disposed on the vehicle's axles. In one configuration, sensors may be located at vehicle's center of gravity, positions of air springs, and vehicle's axles. The roll rate sensors and pitch rate sensors may monitor roll conditions of the vehicle according to a measured height of one or more points on the vehicle relative to the ground surface. Collectively, the sensors are adapted for measuring the vehicle dynamic response, operator input, autonomous system commands, and any other input or response that is critical for successfully and safely determining the suspension forces so that the vehicle may maneuver and interact with the environment in an optimal fashion.

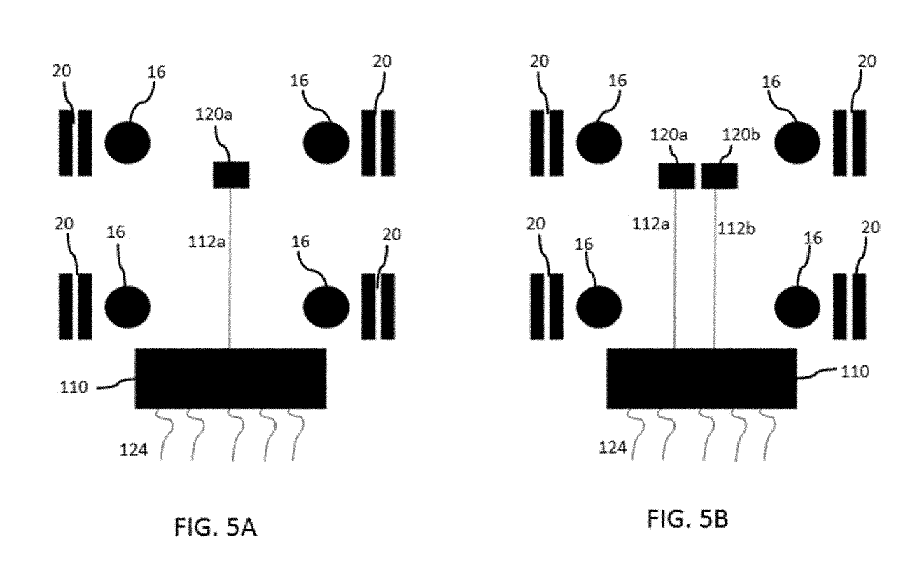

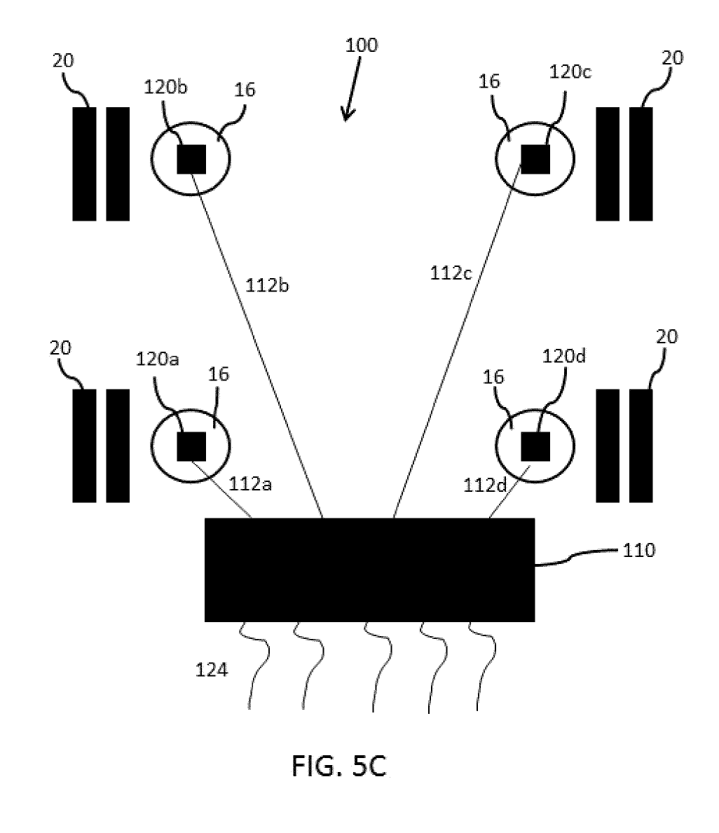

As shown in FIGS. 5A-C, 6, and 8, the CCM 110 receives information from the sensors as sensory input 124 and output commands to the EPD valves 120a-d of the EDC leveling system 100 as electrical signals transmitted along the wiring 112a-d. To generate commands to the EPD valves 120a-d, the CCM 110 analyzes the sensor input according to a control methodology that integrates the sensory inputs into mathematical formulations, which determines the most suitable response for the EPD valve in terms of adjusting the internal pressure of the air springs through the removal or supply of air. The CCM 110 includes software, which embodies the control strategy and mathematical formulations, and memory, such as volatile and/or nonvolatile memory, to store all the necessary software. The CCM 110 further includes one or more (micro)processors linked to the memory by a bus, in which the one or more (micro)processors are adapted to execute the software embodying the control strategy and mathematical formulations. The CCM 110 also includes one or more connectors, receivers, transmitters, and transceivers linked to all the sensors, the one or more EPD valves 120a-d, and the V2X, thereby establishing electrical communication, either wired or wireless, between the one or more (micro)processors of the CCM 110 and all the components of the EDC leveling system 100. Accordingly, the CCM 110 is adapted to receive all the necessary input to calculate a desired air pressure for each air spring 16 of the pneumatic suspension system 10 and convey commands in terms of supplying or purging air to all EPD valves 120a-d.

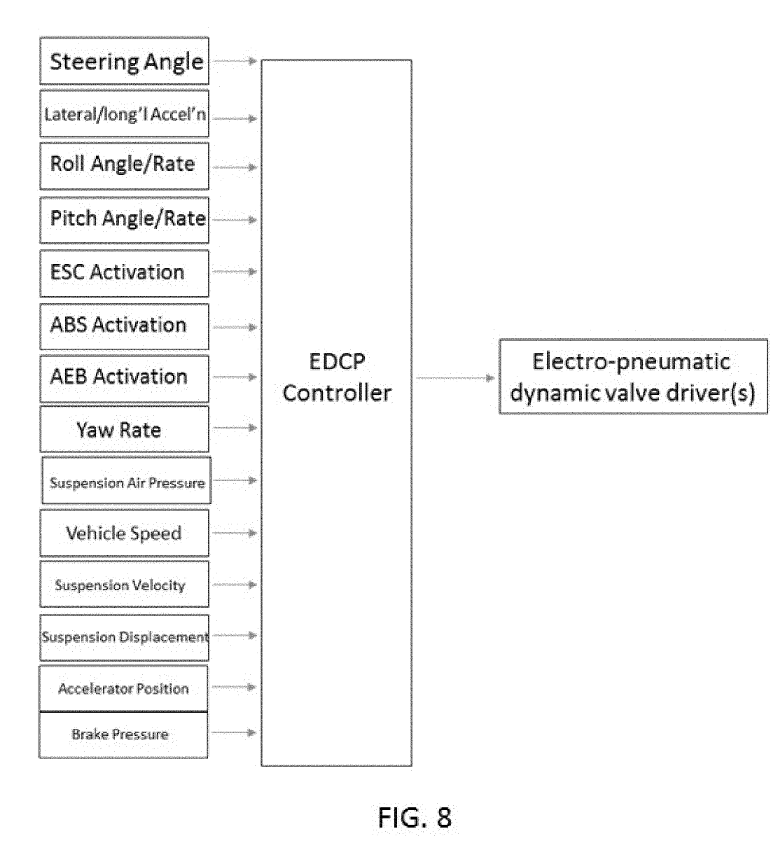

Referring to FIG. 8, examples of sensory inputs for the EDC leveling system 100 include steering input, speed, direction of driving, driver steering and acceleration/braking input, body response, suspension response, suspension displacement, vehicle yaw and any and all dynamics that are critical to measuring and predicting the vehicle roll stability, and pitch dynamics during acceleration and braking. In particular, types of acceleration include lateral, longitudinal, and vertical acceleration at various strategic locations along the vehicle, such as the vehicle's center of gravity and the positions along the vehicle frame or axle that are adjacent to the air springs 16. The EDC leveling system 100 further includes one or more pressure sensors, in which each sensor is configured to monitor the internal pressure of a respective air spring. The EDC leveling system 100 is configured to operate congruently with active safety systems such as Roll Stability Control (RSC), Electronic Stability Control (ESC), Antilock Brake System (ABS), Positive Traction Control (PTC), Automated Emergency Braking (AEB), collision avoidance systems, and all other such systems. Any and all sensory inputs used for active safety systems, collision avoidance systems, driver-assisted systems, semi-autonomous vehicles, and autonomous vehicles serve as sensory input for EDC leveling system 100. In addition to the list of sensory inputs shown in FIG. 8, the sensory input to the EDCP controller can include other information on the vehicle's CAN bus or other similar communication protocols. The CAN bus is a vehicle bus standard designed to allow microcontrollers and devices to communicate with each other in applications without a host computer.

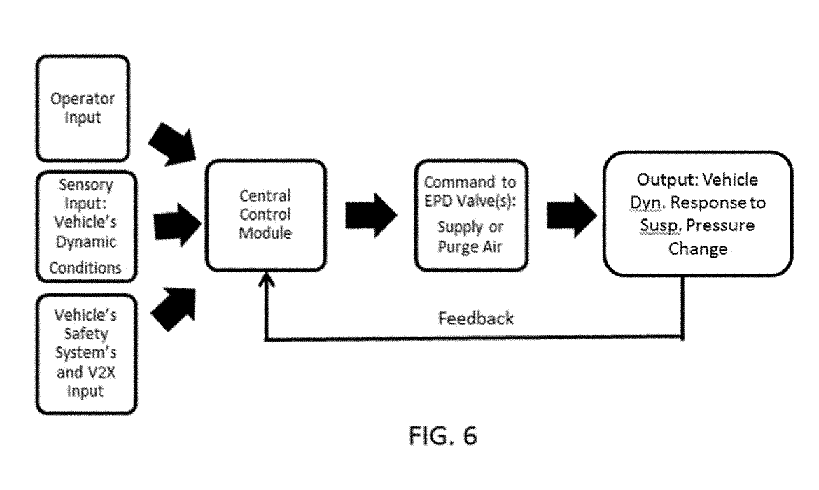

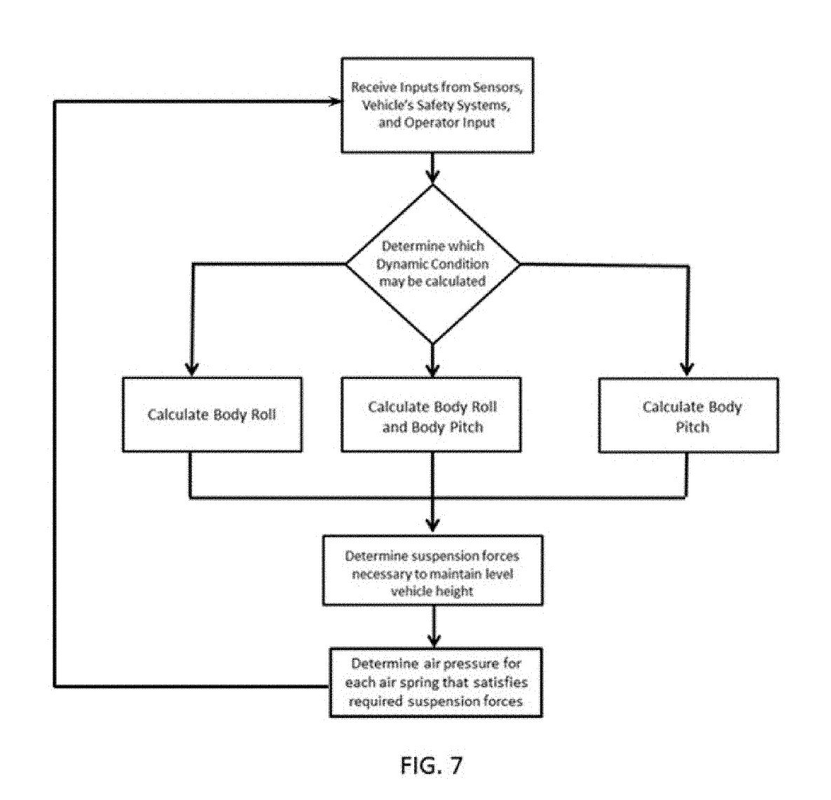

Referring to FIG. 6, the EDC leveling system 100 operates as a closed-loop control system to maintain desired air pressures for each air spring 16 of the pneumatic suspensions system 10. As shown in FIG. 7, the CCM first receives information from the operator input, the sensory input, and the vehicle's safety systems or V2X input. The CCM then determines the desired air pressure for each individual air spring of the pneumatic suspension system based on the operator input, the sensory input, and the vehicle's safety systems or V2X input. In determining the desired air pressure for each individual air spring, the CCM first calculates or estimates the vehicle's dynamic conditions as a function of the sensory input. The calculated vehicle's dynamic conditions may include the vehicle roll stability and pitch dynamics while the vehicle is accelerating and breaking. The sensory input used to calculate the vehicle's dynamic conditions may include the lateral, longitudinal, and vertical acceleration at strategic locations along the vehicle, vehicle yaw input, steering input, vehicle speed, and suspension displacement and velocity. By determining the dynamic conditions of the vehicle, the CCM may then determine the suspension forces necessary to maintain the vehicle at a leveled position. Accordingly, the CCM determines an air pressure for each air spring that satisfies a condition, in which the suspension forces provide a net moment that counters lateral or longitudinal forces against the vehicle's center of gravity. Once determining the desired air pressure for each air spring, the CCM outputs commands to each EPD valve to alter the internal pressure of the air springs accordingly. The new state of the vehicle body is re-evaluated by the sensors and the CCM's actions are repeated, as shown by the closing loop in FIG. 7.

As shown in FIG. 6, the CCM may receive feedback from the plurality of sensors to ensure the air springs are adjusted to a desired air pressure or any other mechanical property. For example, the CCM may receive feedback from pressure sensors to determine the adjusted air pressure of the air springs. Alternatively, the CCM may receive feedback from the displacement sensors to determine the adjusted displacement of the suspension system. The CCM may further adjust the air pressure of the air springs based on the feedback from the plurality of sensors, thereby ensuring the vehicle is maintained at a leveled height.

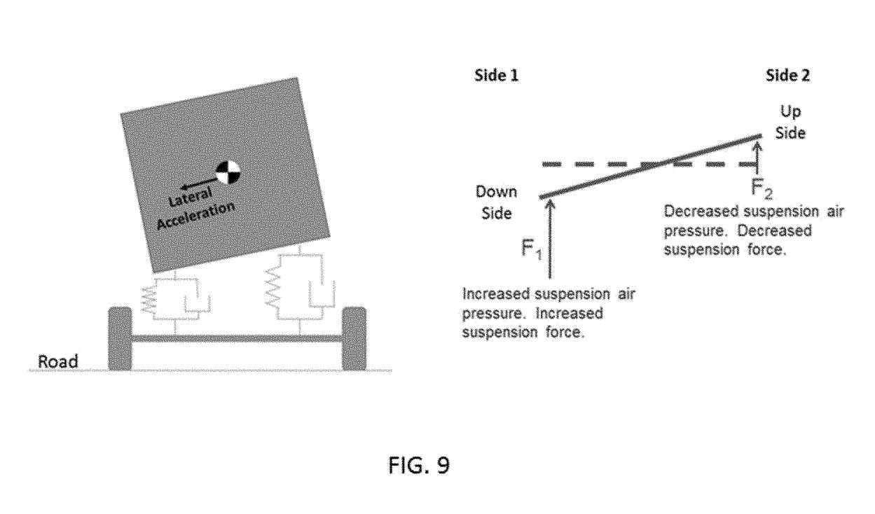

FIG. 9 illustrates one scenario when the vehicle experiences a dynamic weight shift, such as negotiating a turn, and how the pressure is adjusted amongst the air springs. The dynamic weight shift causes one set of air springs to compress and the other set of air springs to extend away from the vehicle axle. In response, the EDC leveling system 100 increases the air pressure of the compressed air springs and decreases the air pressure of the extended air springs in order to generate suspension forces that are conducive to leveling the vehicle in case of roll or pitch. The suspension force on one side increases while suspension force on the other side reduces. The force differential between the first and second sides of the vehicles results in a net moment that counters the moment caused by the lateral or longitudinal forces against the vehicle's center of gravity. To ensure that the suspension system provides the necessary force, the CCM may determine the required air pressure for each air spring based on a calculated/estimated body roll of the vehicle. The EDC leveling system may calculate the body roll based on various available sensory inputs, as described in detail below.

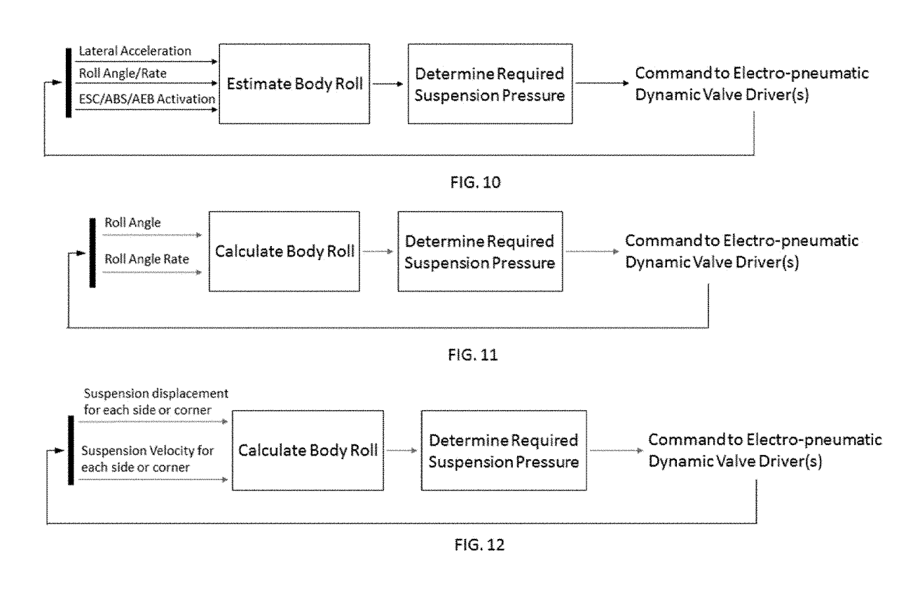

As shown in FIG. 10, the CCM may calculate the vehicle's body roll based on the vehicle's lateral acceleration, vehicle's roll angle and rate, and input activation from the vehicle's ESC, ABS, and AEB. Maneuvers that cause the vehicle body to roll side to side, such as the scenario described above, result in lateral accelerations at the vehicle's center of gravity. Accordingly, the vehicle's body rolls against the suspension at a roll angle and a roll rate that is directly proportional to the lateral accelerations. Sensors of the EDC leveling system 100, such as a lateral acceleration sensor, roll rate sensor, or a gyro, are configured to measure the lateral acceleration, roll angle, and roll rate of the vehicle and input these values to the CCM. In addition, the vehicle's active safety devices, such as the ABS, ESC, AEB, the Lane Departure Warning System, and the Collision Warning System, may activate to maintain the directional stability and overall safety of the vehicle. If the vehicle's active safety devices are activated, the CCM is configured to receive input values from the vehicle's active safety devices via the vehicle's CAN bus. After receiving sensory input that includes the vehicle's lateral acceleration, roll angle, and roll rate and input from the vehicle's active safety devices, the CCM estimates the vehicle's body roll. Based on the estimated body roll value, the CCM determines the suspension force required by each air spring to provide a net moment that counters the moment caused by the lateral or longitudinal forces against the vehicle's center of gravity. The CCM then determines the required air pressure for each air spring of the pneumatic suspension system to provide the suspension force necessary to keep the vehicle in a level position. After determining the desired air pressure for each air spring, the CCM commands the EPD valves to adjust the internal pressure of the air springs accordingly in terms of adding or removing air.

FIGS. 11 and 12 show alternative methods to calculate the vehicle's body roll based on different inputs. Referring to FIG. 11, input from the vehicle's safety devices is not available, along with the lateral acceleration of the vehicle. The CCM receives sensory input that only includes roll angle and roll angle rate. Although the CCM only receives the roll angle and roll rate as inputs, it may still calculate the vehicle's body roll based on mathematical algorithms embedded in software that is stored in the memory of the CCM. Accordingly, the CCM determines a desired air pressure for each air spring based on the vehicle's body roll and commands the EPD valves to adjust the internal pressure of the air springs accordingly.

FIG. 12 shows a method of calculating the vehicle's body roll based on the suspension displacement and suspension velocity. Sensors of the ECD suspension system 100, such as a height sensor, are configured to measure the suspension displacement on each side of the vehicle and the rate of change of displacement across the suspension (i.e., suspension velocity). The sensors input these values to the central control module, which allows the CCM to calculate how rapidly the vehicle's body roll is changing. The CCM may then determine a desired air pressure for each air spring based on how the vehicle's body roll is changing and output commands to the EPD valves in terms of adding or removing air from the air springs. Accordingly, the ECD suspension system not only reacts to the body roll but also anticipates how the body roll is changing, ultimately making the pneumatic suspension system more effective in stabilizing the vehicle.

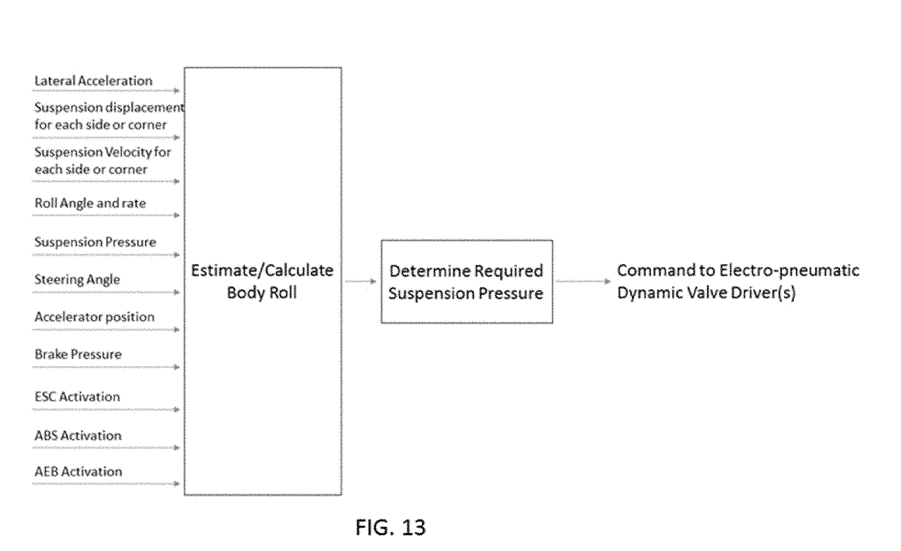

FIG. 13 shows an overall arrangement for implementing a multitude of sensors onboard a vehicle to directly calculate or estimate a vehicle's body roll. The CCM may directly calculate the vehicle's body roll depending on data, such as suspension travel, lateral acceleration, or roll angle. In comparison, the CCM may estimate the vehicle's body roll depending on data, such as steering angle, accelerator position, and brake pressure. The collection of the data shown in FIG. 13 allows a determination of the required suspension forces based on a more sophisticated and complete assessment of the vehicle's body roll.

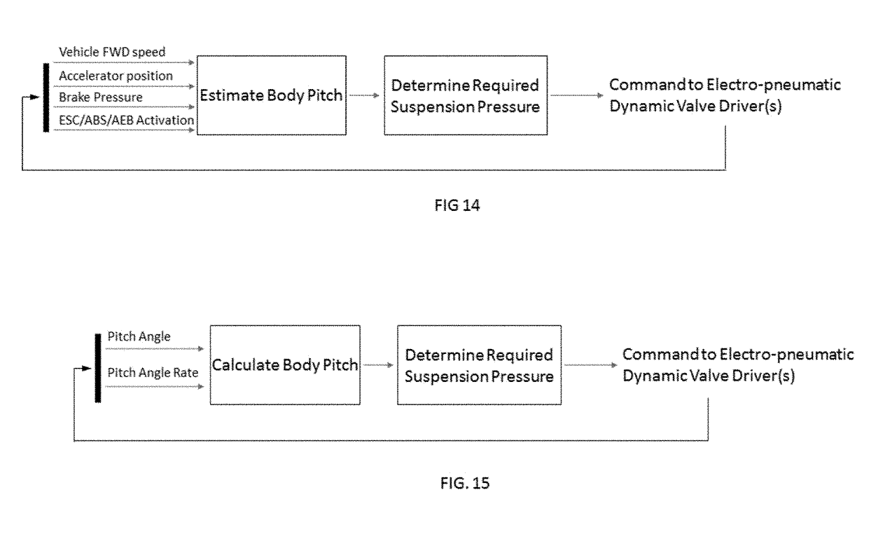

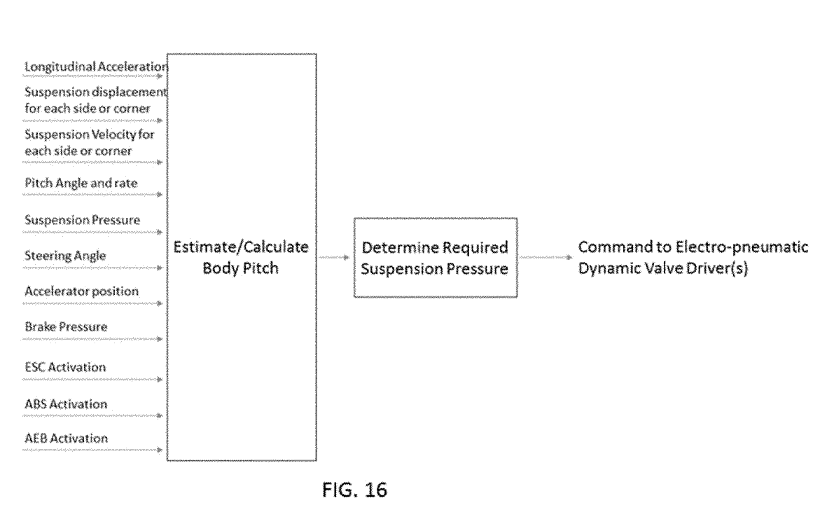

Rather than determining the air pressure for each air spring based on the vehicle's body roll, the CCM may determine air pressure for each air spring based on the body pitch as the dynamic condition of the vehicle. The body pitch may be calculated during dynamic events, such as acceleration and deceleration of the vehicle. Referring to FIG. 14, sensor inputs for the CCM include the vehicle's forward speed, accelerator position, and brake pressure. In addition, the central control module 110 may receive input from vehicle's safety devices, such as ESC, ABS, AEB activation. Accordingly, the CCM estimates the longitudinally dynamics of the vehicle when the vehicle is accelerating and braking. The required suspension forces for preventing the vehicle from excessive pitch are then calculated based on the longitudinal dynamics of the vehicle, in the sense of “dive” during braking or “squad” during acceleration. Referring to FIG. 15, the body pitch may be calculated by inputting the pitch angle and the pitch angle rate to the central control module 110. The control arrangement of FIG. 15 may be implemented as an alternative to or be used in conjunction with the arrangement shown in FIG. 14.

FIG. 16 shows an overall arrangement for implementing a multitude of sensors onboard a vehicle to directly calculate or estimate a vehicle's body pitch. The CCM may directly calculate the vehicle's body pitch depending on data, such as the pitch angle and the pitch angle rate. Alternatively, the CCM may estimate the vehicle's body pitch depending on data, such as vehicle's forward speed, accelerator position, and brake pressure. Similar to the arrangement shown in FIG. 13 for determining the vehicle's body roll, the arrangement shown in FIG. 16 allows a determination of the required suspension forces based on a more sophisticated and complete assessment of the vehicle's body pitch. The CCM may further determine the desired air pressure for each air spring based on both the calculated or estimated body roll, as shown in FIG. 13, and the calculated or estimated body pitch, as shown in FIG. 15. For any and all system configurations shown in FIGS. 8, and 10-16, the new state of the vehicle is re-evaluated by the sensors and control process repeated, in a closed-loop formation.

According to each configuration described above, the ECD suspension system is configured to control proactively the air pressures of each individual air spring to provide a suspension force that satisfies a condition, in which the suspension force creates a net moment that counters the moment caused by vehicle's dynamic conditions that act against the vehicle's center of gravity. Consequently, the ECD suspension system enables the vehicle to maneuver and interact with the environment in an optimal fashion.

As used herein, the term “body roll” refers to the angular motion of the vehicle body relative to its longitudinal axis, i.e., the axis that extends from the back of the vehicle to front.

As used herein, the term “body pitch” refers to the angular motion of the vehicle about its lateral axis, the axis extending from one side to the opposite side of the vehicle

While the subject matter of this disclosure has been described and shown in considerable detail with reference to certain illustrative embodiments, including various combinations and sub-combinations of features, those skilled in the art will readily appreciate other embodiments and variations and modifications thereof as encompassed within the scope of the present disclosure. Moreover, the descriptions of such embodiments, combinations, and sub-combinations is not intended to convey that the claimed subject matter requires features or combinations of features other than those expressly recited in the claims. Accordingly, the scope of this disclosure is intended to include all modifications and variations encompassed within the spirit and scope of the following appended claims.

1. An electro-dynamically controlled leveling system for a vehicle comprising:
a plurality of air springs mounted on at least one axle of the vehicle for supporting the weight of the vehicle;
one or more electro-pneumatic valves configured to adjust the air pressure of the plurality of air springs by supplying air to the plurality of air springs from an air source and removing air from the plurality of air springs;
one or more sensors configured to monitor one or more characteristics of the vehicle and transmit the one or more characteristics as a sensory input; and
a central control module in electrical communication with the one or more sensors and the one or more electro-pneumatic valves,
wherein the central control module is configured to receive the sensory input from the one or more sensors, calculate a dynamic condition of the vehicle based on the sensory input, determine a desired air pressure for each air spring based on the calculated dynamic conditions of the vehicle, and transmit a command to the one or more electro-pneumatic valves to adjust the air pressure of each air spring to the desired air pressure.

2. The electro-dynamically controlled leveling system of claim 1, wherein the one or more characteristics of the vehicle are selected from the group consisting of a steering angle, vehicle lateral acceleration, vehicle longitudinal acceleration, roll angle of the vehicle, roll rate of the vehicle, pitch angle of the vehicle, pitch rate of the vehicle, yaw rate of the vehicle, air pressure of the plurality of air springs, vehicle speed, suspension displacement, suspension velocity, accelerator position, and brake pressure.

3. The electro-dynamically controlled leveling system of claim 1, wherein the dynamic condition is selected from the group consisting of the vehicle's body roll, the vehicle's body pitch, and both the vehicle's body roll and body pitch.

4. The electro-dynamically controlled leveling system of claim 1, wherein the dynamic condition includes the vehicle's body roll and the one or more characteristics of the vehicle include vehicle lateral acceleration, roll angle, and roll rate.

5. The electro-dynamically controlled leveling system of claim 1, wherein the dynamic condition includes vehicle's body roll and the one or more characteristics of the vehicle include suspension displacement and suspension velocity.

6. The electro-dynamically controlled leveling system of claim 1, wherein the dynamic condition includes vehicle's body pitch and the one or more characteristics of the vehicle include a forward speed of the vehicle, an accelerator position of the vehicle, and a brake pressure.

7. The electro-dynamically controlled leveling system of claim 1, wherein one or more characteristics of the vehicle is used in a closed-loop fashion for continually assessing the vehicle body dynamics.

8. The electro-dynamically controlled leveling system of claim 1, wherein the electro-pneumatic valves comprises:
a valve body having one or more airflow passages in pneumatic communication with an air source, the atmosphere, and at least one of the air springs, and
an actuator mechanism configured to open or close the airflow passages of the valve body, wherein the central control module is configured to trigger the actuator mechanism by electrical communication to open or close the airflow passages of the valve body.

9. The electro-dynamically controlled leveling system of claim 8, wherein the valve body comprises a chamber connected to the one or more flow passages and a disk configured to rotate between one or more angular positions within a chamber of the valve body to alter pneumatic communication between the flow passages, and wherein the actuator mechanism comprises a stepper motor configured to induce rotation of the rotary disk to the one or more angular positions.

10. The electro-dynamically controlled leveling system of claim 8, wherein the valve body comprises a manifold having a spring port, a supply port, an exhaust port, and a chamber connected with the spring port, supply port, and exhaust port, and wherein the actuator mechanism comprises a solenoid and a poppet received in the chamber of the manifold, and the poppet is configured to slide between a first and second position to alter pneumatic communication between the spring port, the supply port, and the exhaust port, and the central control module is configured to control movement of the poppet by triggering the solenoid via electrical communication.

11. A method for controlling roll stability and ride comfort of a vehicle comprising:
providing an electro-dynamically controlled leveling system, wherein the electro-dynamically controlled leveling system includes:
a plurality of air springs mounted on at least one axle of the vehicle for supporting the weight of the vehicle;
one or more electro-pneumatic valves configured to adjust the air pressure of the plurality of air springs by supplying air to the plurality of air springs from an air source and removing air from the plurality of air springs;
one or more sensors configured to monitor one or more characteristics of the vehicle and transmit the one or more characteristics as a sensory input;
a central control module in electrical communication with the one or more sensors and the one or more electro-pneumatic valves
receiving, by the central control module, the sensory input from the one or more sensors,
calculating, by the central control module, a dynamic condition of the vehicle based on the sensory input,
determining, by the central control module, a desired air pressure for each air spring based on the calculated dynamic conditions of the vehicle, and
transmitting, by the central control module, a command to the one or more electro-pneumatic valves to adjust the air pressure of each air spring to the desired air pressure, and
re-evaluating, by the central control module, the dynamic condition of the vehicle in response to an adjustment of air pressure for each air spring by the one or more electro-pneumatic valves based on feedback from the one or more sensors, and
re-adjusting, by the central control module and electro-pneumatic valves, the air pressure of each air spring to maintain the vehicle at a desired dynamic state.

12. The method for controlling roll stability and ride comfort of a vehicle of claim 11, wherein the one or more characteristics of the vehicle are selected from the group consisting of a steering angle, vehicle lateral acceleration, vehicle longitudinal acceleration, roll angle of the vehicle, roll rate of the vehicle, pitch angle of the vehicle, pitch rate of the vehicle, yaw rate of the vehicle, air pressure of the plurality of air springs, vehicle speed, suspension displacement, suspension velocity, accelerator position, and brake pressure.

13. The method for controlling roll stability and ride comfort of a vehicle of claim 11, wherein the dynamic condition is selected from the group consisting of the vehicle's body roll, the vehicle's body pitch, and both the vehicle's body roll and body pitch.

14. The method for controlling roll stability and ride comfort of a vehicle of claim 11, wherein the electro-pneumatic valves comprises:
a valve body having one or more airflow passages in pneumatic communication with an air source, the atmosphere, and at least one of the air springs, and
an actuator mechanism configured to open or close the airflow passages of the valve body, wherein the central control module is configured to trigger the actuator mechanism by electrical communication to open or close the airflow passages of the valve body.

15. The method for controlling roll stability, ride comfort, and road holding of a vehicle of claim 14, wherein the valve body comprises a chamber connected to the one or more flow passages and a disk configured to rotate between one or more angular positions within a chamber of the valve body to alter pneumatic communication between the flow passages, and wherein the actuator mechanism comprises a stepper motor configured to induce rotation of the rotary disk to the one or more angular positions.

16. The method for controlling roll stability, ride comfort, and road holding of a vehicle of claim 14, wherein the valve body comprises a manifold having a spring port, a supply port, an exhaust port, and a chamber connected with the spring port, supply port, and exhaust port, and wherein the actuator mechanism comprises a solenoid and a poppet received in the chamber of the manifold, and the poppet is configured to slide between a first and second position to alter pneumatic communication between the spring port, the supply port, and the exhaust port, and the central control module is configured to control movement of the poppet by triggering the solenoid via electrical communication.
